(19) United States
(12) Patent Application Publication
(10) Pub. No.: US 2026/0093262 A1
(43) Pub. Date: Apr. 2, 2026

(54) INFORMATION PROCESSING APPARATUS, INFORMATION PROCESSING METHOD, MOBILE OBJECT, STORAGE MEDIUM, AND SYSTEM

(71) Applicant: HONDA MOTOR CO., LTD., Tokyo (JP)

(72) Inventors: Akane IMAIZUMI, Wako-shi (JP); Sango MATSUZAKI, Tokyo (JP)

(21) Appl. No.: 19/332,165

(22) Filed: Sep. 18, 2025

(30) Foreign Application Priority Data
Sep. 30, 2024 (JP) 2024-171483

(51) Int. Cl. G05D 1/633; G05D 109/10; G06T 7/20; G06T 7/70

(52) U.S. Cl. CPC G05D 1/633; G06T 7/20; G06T 7/70; G05D 2109/10; G06T 2207/30241; G06T 2207/30261

(57) ABSTRACT

An information processing apparatus is configured to estimate a destination of movement of a dynamic object. The information processing apparatus selects a plurality of geographic locations from a vicinity of the dynamic object, uses a likelihood function to calculate a likelihood that each geographic location is the destination, for each of the plurality of geographic locations, reselects the plurality of geographic locations based on the likelihood of each geographic location, and estimates the destination based on the plurality of reselected geographic locations. The likelihood function is based on at least one of a state of the dynamic object and a position of an obstacle around the dynamic object.

### CROSS-REFERENCE TO RELATED APPLICATION(S)

This application claims priority to and the benefit of Japanese Patent Application No. 2024-171483, filed Sep. 30, 2024, the entire disclosure of which is incorporated herein by reference.

### BACKGROUND OF THE INVENTION

### Field of the Invention

The present disclosure relates to an information processing apparatus, an information processing method, a mobile object, a storage medium, and a system.

### Description of the Related Art

In order to assist a user, an autonomous mobile robot capable of tracking the user is provided. In the technique described in Japanese Patent Laid-Open No. 2021-77088, in order to cause the autonomous mobile robot to track the user with more natural behavior, a virtual tracking goal different from a tracking target is set.

### SUMMARY OF THE INVENTION

In order to control a mobile object, a destination of movement of a dynamic object around the mobile object may be used. Some aspects of the present disclosure provide a technique for accurately estimating the destination of movement of the dynamic object.

According to some embodiments, an information processing apparatus configured to estimate a destination of movement of a dynamic object is provided. The information processing apparatus comprising: a selection unit configured to select a plurality of geographic locations from a vicinity of the dynamic object; a calculation unit configured to use a likelihood function to calculate a likelihood that each geographic location is the destination, for each of the plurality of geographic locations; a reselection unit configured to reselect the plurality of geographic locations based on the likelihood of each geographic location; and an estimation unit configured to estimate the destination based on the plurality of reselected geographic locations, wherein the likelihood function is based on at least one of a state of the dynamic object and a position of an obstacle around the dynamic object.

### BRIEF DESCRIPTION OF THE DRAWINGS

FIG. 1 is a schematic diagram illustrating an external configuration example of a mobile object according to some embodiments;

FIG. 2 is a block diagram for describing a functional configuration example of the mobile object according to some embodiments;

FIG. 3 is a flowchart for describing a control method of the mobile object according to some embodiments;

FIG. 4 is a schematic diagram illustrating a decision method of a target place of a dynamic object according to some embodiments; and

FIG. 5 is a schematic diagram illustrating a decision method of a likelihood function according to some embodiments.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Configuration of Mobile Object

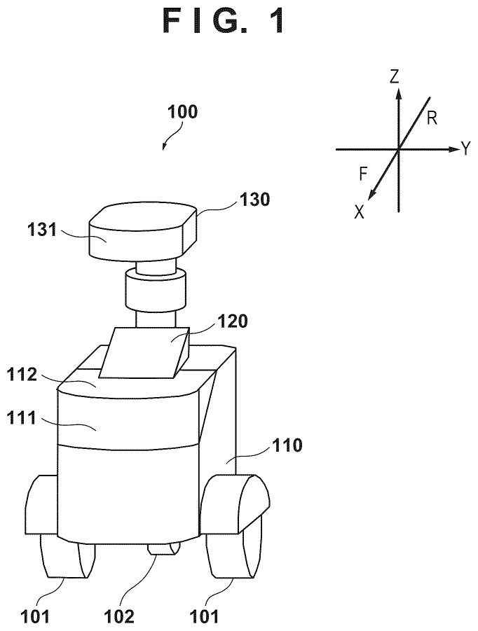

An external configuration example of a mobile object 100 according to some embodiments will be described with reference to FIG. 1. An arrow X in FIG. 1 indicates a front-and-rear direction of the mobile object 100. F indicates the front, and R indicates the rear. Arrows Y and Z respectively indicate a width direction (left-and-right direction) and an up-and-down direction of the mobile object 100. The mobile object 100 is autonomously movable. For example, the mobile object 100 is equipped with a battery, and moves mainly by power of a motor. The mobile object 100 may be used within premises such as an amusement facility, a large commercial facility, an airport, a park, a sidewalk, or a parking lot. The mobile object 100 may be a vehicle that moves on the ground using wheels, an aircraft (for example, a drone) that moves through the air, or a robot that moves on the ground using two or more legs. The movement using wheels is also referred to as traveling. The movement through the air is referred to as flying. The movement using two or more legs is referred to as walking. Hereinafter, a case where the mobile object 100 is a vehicle will be described, but the same description applies to other forms of mobile objects.

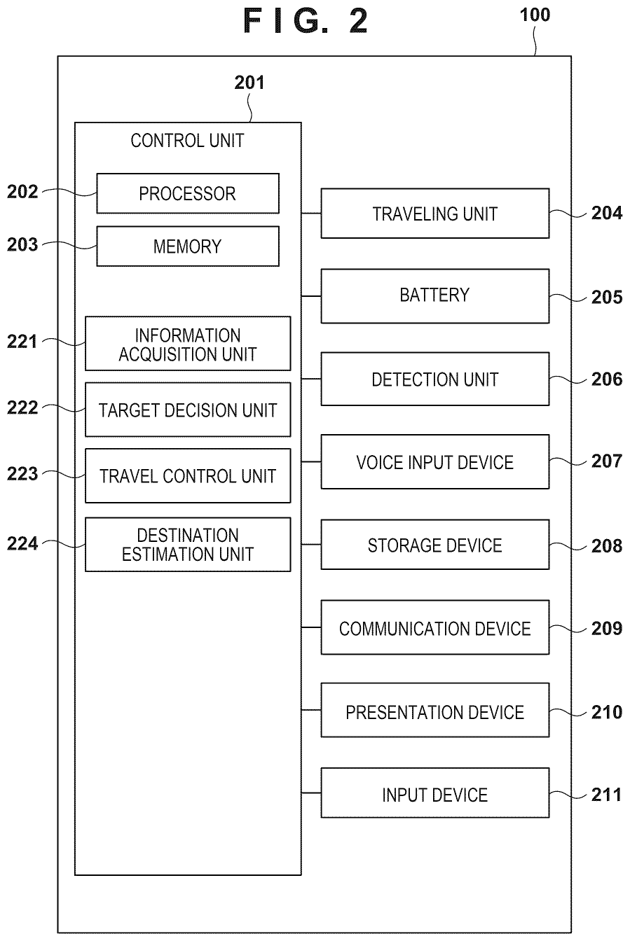

The mobile object 100 is movable so as to accompany a user of the mobile object 100 (hereinafter simply referred to as a “user”). Accompanying the user means that the mobile object 100 moves based on the user's leading movement. In the following examples, a configuration in which no person rides in the mobile object 100 is described, but the mobile object 100 may carry a person different from the user. The mobile object 100 includes, for example, a pair of left and right front wheels 101 and a rear wheel 102, which are included in a traveling unit 204 (FIG. 2). The traveling unit 204 may be in another form such as a four-wheeled vehicle or a two-wheeled vehicle. The mobile object 100 may be autonomously movable to a destination set in advance, instead of or in addition to accompanying the user of the mobile object 100.

The mobile object 100 includes a housing 110 capable of housing a load. A lid that is openable and closable to house a load is provided on a front surface 111 of the housing, and the lid includes a lock mechanism. The lock mechanism is controlled by the mobile object 100. For example, the mobile object 100 releases a locked state in a case where the authentication of the user is successful. Alternatively, the mobile object 100 may be capable of housing a load in another manner.

A touch screen 120 is disposed on an upper surface 112 of the housing, and the user can, for example, change settings of the mobile object 100 or check information regarding the facility. A sensor box 130 includes, inside thereof, a detection unit 206 such as a camera (FIG. 2). The detection unit 206 observes the user and other objects included in the environment surrounding the mobile object 100 through a front surface 131, side surfaces, and a rear surface of the sensor box 130.

### Functional Configuration Example of Mobile Object

A functional configuration example of the mobile object 100 will be described with reference to FIG. 2. The mobile object 100 includes components illustrated in FIG. 2. The mobile object 100 may include components not illustrated in FIG. 2, or may not include some components illustrated in FIG. 2.

The mobile object 100 is an electric autonomous mobile object including the traveling unit 204 and using a battery 205 as a main power source. The battery 205 is, for example, a secondary battery such as a lithium ion battery, and the traveling unit 204 causes the mobile object 100 to travel autonomously using power supplied from the battery 205.

The traveling unit 204 performs acceleration and deceleration of the mobile object 100 by changing the rotational speed of the pair of front wheels 101 using a motor as a drive source. The traveling unit 204 may include a braking mechanism for decelerating the mobile object 100. The traveling unit 204 performs steering of the mobile object 100 by differentiating the rotational speeds between the pair of front wheels 101. The traveling unit 204 is capable of detecting and outputting physical quantities representing the motion of the mobile object 100, such as a traveling speed, acceleration, a steering angle of the mobile object 100, and angular velocity and angular acceleration of the housing 110 of the mobile object 100.

The mobile object 100 includes the detection unit 206 including one or more sensors. The detection unit 206 generates data for recognizing objects included in the environment surrounding the mobile object 100 (including a physical object and a person included in the environment surrounding the mobile object 100). The detection unit 206 includes sensors such as an imaging device (camera), a radar device, a Light Detection and Ranging (LiDAR), and an ultrasonic sensor which have a detection range covering the surroundings of the mobile object 100, and outputs sensor information. The imaging device may have a configuration using a fisheye lens, or a configuration capable of stereo imaging. Furthermore, the detection unit 206 includes a Global Navigation Satellite System (GNSS) sensor, receives a GNSS signal, and detects a current position of the mobile object 100. The detection unit 206 may detect the current position using signals from a wireless Local Area Network (LAN) or Bluetooth. The imaging device may be an RGB camera and may further have a depth measurement function. For example, the mobile object 100 may have RGB cameras with a depth measurement function on the front and rear sides of the sensor box 130, and RGB cameras without a depth measurement function on the right and left sides of the sensor box 130.

The mobile object 100 includes a control unit (Electronic Control Unit (ECU)) 201. The control unit 201 functions as a control device of the mobile object 100. The control unit 201 includes one or more processors 202 represented by a Central Processing Unit (CPU), and a memory 203 that is a storage device such as a semiconductor memory. Therefore, the control unit 201 may also be referred to as an information processing apparatus or a computer. The memory 203 stores a program to be executed by the processor 202, data used by the processor 202 for the processing, and the like. A plurality of sets of the processor 202 and the memory 203 may be provided for each function of the mobile object 100 in such a way as to be able to communicate with each other.

The control unit 201 acquires physical quantities representing the motion output from the traveling unit 204, detection results from the detection unit 206, input information from the touch screen 120, voice information input from a voice input device 207, and the like, and executes corresponding processing. For example, the control unit 201 performs control of the motor of the traveling unit 204, display control of the touch screen 120, notification to the surrounding environment by voice, and the like.

The voice input device 207 collects voices from the environment surrounding the mobile object 100. The control unit 201 can recognize the input voice and execute the corresponding processing. A storage device 208 is a non-volatile, large-capacity storage device that stores map information including information such as a traveling road on which the mobile object 100 can travel travelable, regions where entry is restricted, landmarks, and stores. The storage device 208 may also store programs to be executed by the processor 202 and data used by the processor 202 for processing. A communication device 209 is a communication device capable of connecting to an external network via wireless communication, such as 5th generation mobile communication or wireless LAN.

A presentation device 210 displays (presents) a user interface screen for the user on the touch screen 120, and outputs (presents) a spoken voice to the environment surrounding the mobile object 100 via a microphone. An input device 211 includes, for example, a touch panel, and may be configured integrally with the touch screen 120. The input device 211 receives an operation input from the user via the touch panel.

The processor 202 of the control unit 201 realizes functions of an information acquisition unit 221, a target decision unit 222, a travel control unit 223, and a destination estimation unit 224 by executing a program stored in the memory 203 or the storage device 208. The information acquisition unit 221 acquires various kinds of information used in processing by other components. The target decision unit 222 decides a target position of the mobile object 100 with respect to the user, based on the information acquired by the information acquisition unit 221. The target position refers to a position that serves as a target of the movement destination of the mobile object 100. The travel control unit 223 supplies a control signal to the traveling unit 204 in order to move the mobile object 100. The travel control unit 223 moves the mobile object 100 toward the target position. The destination estimation unit 224 estimates a destination of movement of the dynamic object. Details of the processing performed by the information acquisition unit 221, the target decision unit 222, the travel control unit 223, and the destination estimation unit 224 will be described later.

### Control Method of Mobile Object 100

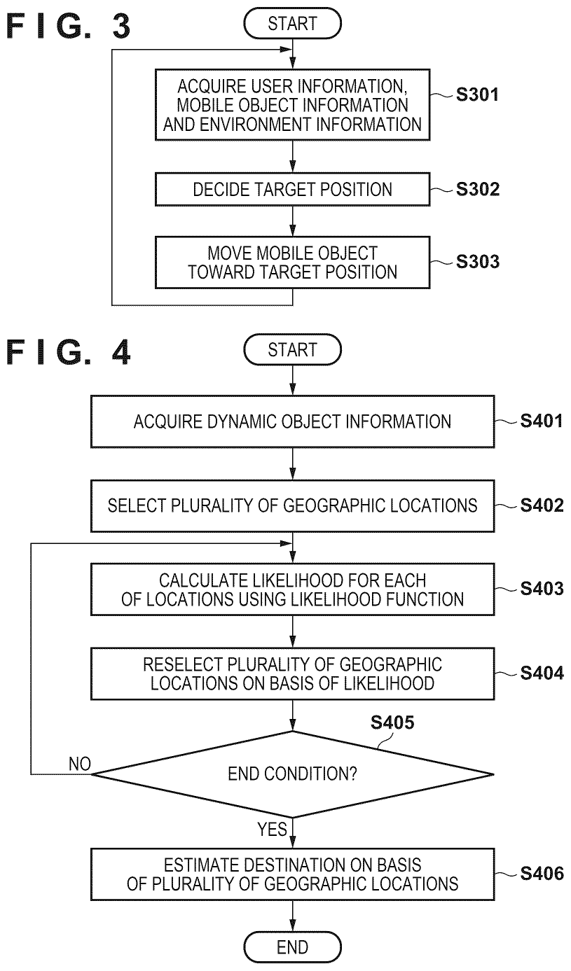

With reference to FIG. 3, a method by which the control unit 201 controls the mobile object 100 will be described. As described above, the control unit 201 is capable of controlling the mobile object 100 to accompany the user. Each step of the method in FIG. 3 may be executed by the processor 202 executing a program stored in the memory 203 or the storage device 208. Alternatively, at least a part of the steps of the method in FIG. 3 may be executed by a dedicated integrated circuit such as an Application Specific Integrated Circuit (ASIC). The method in FIG. 3 may be started in response to the mobile object 100 being instructed by the user to accompany the user. The control unit 201 repeatedly executes the processing of S301 to S303 (for example, at a cycle of 100 ms).

The method in FIG. 3 is executed for the user of the mobile object 100. The control unit 201 specifies the user at the start of the method in FIG. 3, and controls the mobile object 100 to accompany the user. The control unit 201 may specify, as the user, a person positioned in front of the mobile object 100 in an image captured by the detection unit 206 (for example, an imaging device), or a person who has been previously registered as a user. During the execution of the method in FIG. 3, the control unit 201 continuously determines whether the user can be detected. In a case where the user cannot be detected for a predetermined period of time after the user is last detected, the control unit 201 determines that the user has been lost, and interrupts the method in FIG. 3. Thereafter, the control unit 201 may resume the method in FIG. 3 in response to the detection of the user.

In S301, the control unit 201 (for example, the information acquisition unit 221) acquires information to be used in subsequent processing. This information may include user information, mobile object information, and environment information. The control unit 201 may store at least part of the acquired information in the memory 203 or the storage device 208 for use in subsequent processing.

The user information is information regarding the user. The user information may include a current geographical location of the user and a current posture of the user. The control unit 201 may acquire the user information based on the detection result from the detection unit 206 (for example, an image captured by the imaging device).

The mobile object information is information regarding the mobile object 100. The mobile object information may include the current moving speed of the mobile object 100, the current geographic location of the mobile object 100, and the current angular velocity of the mobile object 100. The control unit 201 may acquire the mobile object information based on the output from the traveling unit 204 and the detection result from the detection unit 206 (for example, positioning data from the GNSS or data from an inertial sensor).

The environment information is information regarding the environment surrounding the mobile object 100. The environment information may include the number, types, positions, and sizes of objects included in the environment surrounding the mobile object 100. The object may include a static object and a dynamic object. The static object may include a structure such as a wall, a guardrail, a pole, and a step. The static object refers to an object that is directly or indirectly fixed to the ground and does not move. Among the static objects, the object that may become an obstacle to the movement of the mobile object 100 may be referred to as a static obstacle. The dynamic object may include a pedestrian, a bicycle rider, an autonomous mobile object, an animal, and the like. The dynamic object refers to an object that is movable with respect to the ground. Among the dynamic objects, the object that may become an obstacle to the movement of the mobile object 100 may be referred to as a dynamic obstacle. The control unit 201 may acquire the environment information based on the detection result from the detection unit 206 (for example, an image captured by the imaging device).

In S302, the control unit 201 (for example, the target decision unit 222) decides a target position of the mobile object 100. For example, the control unit 201 may first predict a movement direction in which the user intends to move, based on the various kinds of information acquired in S301. The movement direction of the user may be predicted based on, for example, the orientation of the user's body or the user's past movement path. The control unit 201 may then decide, as the target position, a position that forms a predetermined angle with respect to the predicted movement path and is located at a predetermined distance from the user. The control unit 201 may decide the target position such that the target position does not overlap an obstacle (for example, the static obstacle).

In S303, the control unit 201 (for example, the travel control unit 223) moves the mobile object 100 toward the target position decided in S302. Specifically, the control unit 201 generates a trajectory from the current position of the mobile object 100 toward the target position, and moves the mobile object 100 along this trajectory. Depending on the current posture and speed of the mobile object 100, the trajectory may or may not pass through the target position. Thereafter, the control unit 201 shifts the processing to S301, and repeats the above-described processing.

During the execution of the method in FIG. 3, the control unit 201 may monitor the distance between the mobile object 100 and the dynamic obstacle in around the mobile object 100, and in a case where the distance becomes equal to or less than a threshold value (for example, 1.5 m), may perform an action (for example, a voice announcement) to request the dynamic obstacle to yield the path. Furthermore, during the execution of the method in FIG. 3, in a case where the distance between the mobile object 100 and the dynamic obstacle around the mobile object 100 becomes equal to or less than another threshold value (for example, 1 m), the control unit 201 may stop the mobile object 100. Furthermore, in S303, the control unit 201 may generate a trajectory so as to avoid the dynamic obstacle.

### Acquisition Method of Position of Dynamic Object

With reference to FIG. 4, a method of estimating a destination of movement of a dynamic object will be described. The dynamic object may be the user of the mobile object 100, or another dynamic object included in the environment surrounding the mobile object 100. The destination of movement of the dynamic object refers to a geographic location to which the dynamic object is intending to move. The processing of estimating the destination of movement of the dynamic object may be included in the processing of acquiring the user information and the environment information in S301 of FIG. 3. That is, the method in FIG. 4 may be executed as a part of S301 in FIG. 3. As described above, S301 is executed repeatedly. The method in FIG. 4 may be executed each time S301 is executed, or may be executed at a predetermined frequency relative to the execution of S301. Alternatively, the method in FIG. 4 may be executed in response to a trigger different from the execution of S301.

Each step in FIG. 4 may be executed by the control unit 201 (for example, the destination estimation unit 224). In a case where a plurality of dynamic objects is present around the mobile object 100, the control unit 201 may execute the method in FIG. 4 for each dynamic object, or may execute the method in FIG. 4 for a specific dynamic object (for example, the user of the mobile object 100, a pedestrian around the mobile object 100, or an autonomous mobile robot around the mobile object 100). In the following description of FIG. 4, the dynamic object of which the destination is to be estimated is referred to as a target object. In the method of FIG. 4, the destination is estimated by executing processing similar to a particle filter.

In S401, the control unit 201 acquires information on the target object and information on the environment around the target object. The information on the target object may include, for example, a geographic location of the target object and a movement direction of the target object. The geographic location may be represented by two-dimensional coordinate values on a horizontal plane. The geographic location may be defined as a relative position with respect to the geographic location of the mobile object 100 at the time when the method in FIG. 4 is started, or may be defined by latitude and longitude. The movement direction of the target object is a direction in which the target object is intending to move. The movement direction of the target object may be decided based on, for example, the orientation of the body of the target object or the past movement path of the target object. For example, in a case where the target object is a person, the orientation of the waist of the person may be used as the orientation of the body of the target object (that is, the movement direction of the target object). The orientation of the body of the target object may be decided by analyzing data observed by the detection unit 206 (for example, an image captured by a camera). The information on the environment surrounding the target object may include information on the static obstacle present around the target object. The information on the static obstacle may include a region occupied by the static obstacle.

In S402, the control unit 201 selects a plurality of geographic locations from the vicinity of the dynamic object. The control unit 201 may select a plurality of geographic locations randomly or regularly (for example, in a grid pattern). The plurality of geographic locations may be selected from a specific range on the map (for example, within a predetermined distance from the mobile object 100 or the target object). In the following description, it is assumed that N geographic locations are selected. N may be, for example, 100, 1000, or the like. Each of the plurality of geographic locations corresponds to a particle in the particle filter.

In S403, the control unit 201 calculates a likelihood that the geographic location is the destination, for each of the plurality of geographic locations selected in S402 (or reselected in S404) using a likelihood function. The likelihood function is a function that outputs a likelihood that a specific geographic location is the destination. Specific examples of the likelihood function will be described later.

In S404, the control unit 201 reselects the plurality of geographic locations based on the likelihood of each geographic location. The reselection of the plurality of geographic locations corresponds to resampling in the particle filter. For example, the control unit 201 selects new N geographic locations by repeating, N times, processing of selecting one of the existing N geographic locations according to the likelihood of each geographic location. As a result, the geographic location with a low likelihood among the existing geographic locations is discarded with a high probability (that is, not selected as a new geographic location). On the other hand, the geographic location with a high likelihood among the existing geographic locations is selected with a high probability, and the same geographic location may be selected multiple times in some cases. Thus, some of the new N geographic locations may be the same as each other.

In S405, the control unit 201 determines whether a condition (end condition) for ending the iteration is satisfied. In a case where the end condition is satisfied (YES in S405), the control unit 201 shifts the processing to S406, and in other cases (NO in S405), the control unit 201 shifts the processing to S403. In this manner, S403 to S405 are repeated until the end condition is satisfied. The end condition may be that S403 to S405 are repeated a predetermined number of times (for example, five times). Alternatively or additionally, the end condition may be based on a convergence state of the reselection. For example, in a case where a change amount of the center of gravity of the plurality of geographic locations before and after S404 is smaller than a threshold value, the control unit 201 may determine that the reselection has converged (that is, the end condition is satisfied).

In S406, the control unit 201 estimates the destination based on the plurality of geographic locations at that point in time (that is, the plurality of geographic locations reselected most recently). For example, the control unit 201 estimates the center of gravity of the plurality of geographic locations as the destination. As described above, many geographic locations decided to have high likelihoods by the likelihood function are reselected. Therefore, the destination is decided to be a location with a high likelihood of being the destination.

The control unit 201 may store the destination estimated in S406 in the memory 203 or the storage device 208 for use in subsequent processing. In S303 of FIG. 3 described above, the control unit 201 may control the movement of the mobile object 100 based on the destination of the dynamic object. For example, in a case where the dynamic object is the user of the mobile object 100, the control unit 201 may control the mobile object 100 to move along a predicted trajectory to the destination of the user. In a case where the dynamic object is a dynamic obstacle, the control unit 201 may control the movement of the mobile object 100 so as not to intersect with the predicted trajectory to the destination of the dynamic obstacle.

### Example of Likelihood Function

The likelihood function used in S403 of FIG. 4 may be based on at least one of a state of a goal object and a position of an obstacle around the goal object. Specifically, the likelihood function may be based on at least one of the movement direction of the goal object, whether each geographic location overlaps a static obstacle, and a trajectory along which the goal object is predicted to move in order to reach each geographic location, or may be based on all of these.

For example, a likelihood function p(i) may be given by

$$p ( i ) = \frac{{w}_{d}^{( i )} + {w}_{o}^{( i )} + {w}_{t}^{( i )}}{{\sum }_{i} {w}_{d}^{( i )} + {w}_{o}^{( i )} + {w}_{t}^{( i )}} .$$

In this expression, i represents the number assigned to each of the plurality of geographic locations and is an integer from 1 to N. The numerator is the sum of three terms of W_{d}⁽ⁱ⁾, Wₒ⁽ⁱ⁾, and Wₜ⁽ⁱ⁾. The term W_{d}⁽ⁱ⁾ is a value calculated for the i-th geographic location based on the movement direction of the goal object. The term Wₒ⁽ⁱ⁾ is a value calculated for the i-th geographic location based on whether the geographic location overlaps a static obstacle. The term Wₜ⁽ⁱ⁾ is a value calculated for the i-th geographic location based on a trajectory along which the goal object is predicted to move in order to reach the geographic location. The larger the values of respective terms in the numerator, the larger the value output by the likelihood function p(i). The denominator on the right-hand side is a term for normalizing the likelihood. In the following description, for simplicity, the superscript (i) for each term is omitted.

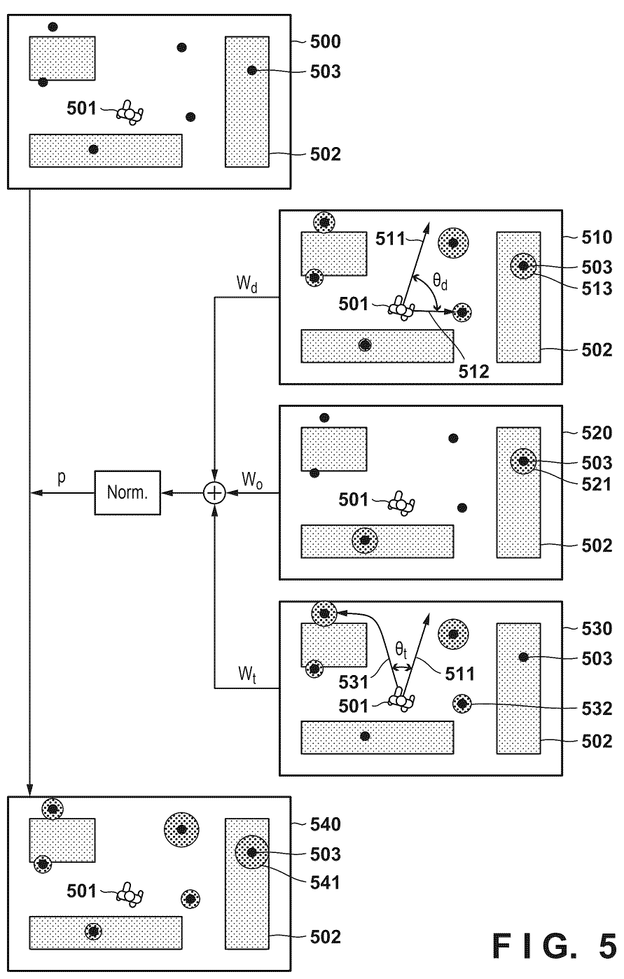

An example of a method of calculating the terms W_{d}, Wₒ, and Wₜ will be described with reference to FIG. 5. A map 500 indicates the environment surrounding a target object 501. A static obstacle 502 is present around the target object 501. In the map 500, three static obstacles 502 are present, and only one of them is provided with a reference numeral. In the map 500, a plurality of geographic locations 503 are selected. In the example of the map 500, six geographic locations 503 are selected, and only one of them is provided with a reference numeral. The plurality of geographic locations 503 may be the geographic locations selected in S402, or the geographic locations reselected in S404.

With reference to a map 510, a method of calculating the term W_{d} based on a movement direction 511 of the target object 501 will be described. In general, there is a high possibility that the target object 501 moves to approach the destination. Therefore, the term W_{d} is calculated to have a larger value as an angle θ_{d} (from 0 degrees to 180 degrees) formed between the movement direction 511 of the target object 501 and a direction 512 from the target object 501 toward each geographic location 503 is smaller.

For example, the term W_{d} may be calculated according to W_{d}=A exp(−θ_{d}). A is a predetermined positive constant, is decided before the execution of a method in FIG. 5, and is stored in the memory 203 or the storage device 208. A region 513 visually indicates the magnitude of the term W_{d} for each geographic location 503. The larger the region 513, the larger the value of the term W_{d}.

With reference to a map 520, a method of calculating the term Wₒ based on whether each geographic location 503 overlaps the static obstacle 502 will be described. The target object 501 may be moving toward one of the static obstacles 502 (for example, a store or a meeting spot). Therefore, the term Wₒ is calculated to have a larger value in a case where each geographic location 503 overlaps the static obstacle 502 than in a case where each geographic location 503 does not overlap the static obstacle 502.

For example, the term Wₒ may be calculated according to

$${W}_{o} = \{ \begin{matrix}B ( when overlapping an obstacle ) \\ 0 ( when not overlapping an obstacle )\end{matrix}$$

B is a predetermined positive constant, is decided before the execution of a method in FIG. 5, and is stored in the memory 203 or the storage device 208. A region 521 visually indicates the magnitude of the term Wₒ for each geographic location 503. The larger the region 521, the larger the value of the term Wₒ.

With reference to a map 530, a method of calculating the term Wₜ based on a trajectory 531 along which the target object 501 is predicted to move in order to reach each geographic location 503 will be described. The target object 501 may be moving in a direction different from a direction in which the destination is present in order to avoid the static obstacle 502. Therefore, the term Wₜ is calculated to have a larger value as an angle θₜ (from 0 degrees to 180 degrees) formed between the trajectory 531 and the movement direction 511 of the target object 501 is smaller. The trajectory 531 is decided based on the current position of the target object 501, each geographic location 503, and the position of the static obstacle 502. The angle θₜ may be an angle formed between the tangent direction of the trajectory 531 at the current position of the target object 501 and the movement direction 511.

For example, the term Wₜ may be calculated according to Wₜ=C exp(−θₜ). C is a predetermined positive constant, is decided before the execution of a method in FIG. 5, and is stored in the memory 203 or the storage device 208. In a case where the geographic location 503 overlaps the static obstacle 502, the term Wₜ becomes zero. A region 532 visually indicates the magnitude of the term Wₜ for each geographic location 503. The larger the region 532, the larger the value of the term Wₜ.

A map 540 represents the likelihood calculated for each geographic location 503 using the likelihood function p(i). A region 541 visually indicates the likelihood for each geographic location 503. The larger the region 541, the larger the likelihood.

As described above, since the likelihood function p(i) is based on at least one of the state of the goal object and the position of the obstacle around the goal object, it is possible to accurately estimate the destination of movement of the target object 501 by the method in FIG. 4. In the above example, the likelihood function p(i) is expressed as a normalized sum of three terms of W_{d}⁽ⁱ⁾, Wₒ⁽ⁱ⁾, and Wₜ⁽ⁱ⁾. Alternatively, the likelihood function p(i) may be given by another operation of these three terms. Furthermore, the likelihood function p(i) may include only one or two of these three terms.

In the above embodiment, the method in FIG. 4 is executed by the control unit 201. Alternatively, at least one step of the method in FIG. 4 may be executed by an external server connected to the mobile object 100 via a network. In other words, the method in FIG. 4 may be executed through cooperation between the external server and the control unit 201. In this case, the server and the control unit 201 constitute an information processing system for controlling the mobile object 100. In addition, in a case where all steps of the method in FIG. 4 are executed by the external server, the external server functions as an information processing apparatus for executing the method in FIG. 4.

### Summary of Embodiments

(Item 1) An information processing apparatus (201) configured to estimate a destination of movement of a dynamic object (501), the information processing apparatus comprising:
a selection unit configured to select a plurality of geographic locations (503) from a vicinity of the dynamic object;
a calculation unit configured to use a likelihood function (p(i)) to calculate a likelihood that each geographic location is the destination, for each of the plurality of geographic locations;
a reselection unit configured to reselect the plurality of geographic locations based on the likelihood of each geographic location; and
an estimation unit configured to estimate the destination based on the plurality of reselected geographic locations,
wherein the likelihood function is based on at least one of a state of the dynamic object and a position of an obstacle (502) around the dynamic object.

According to this item, it is possible to accurately estimate the destination of the movement of the dynamic object.

(Item 2) The information processing apparatus according to Item 1,
wherein the likelihood function is based on a movement direction (511) of the dynamic object.

According to this item, since the intention of the dynamic target can be ascertained based on the movement direction of the dynamic target, it is possible to accurately estimate the destination of the movement of the dynamic object.

(Item 3) The information processing apparatus according to Item 2,
wherein the movement direction of the dynamic object is decided based on an orientation of a body of the dynamic object.

According to this item, it is possible to accurately decide the movement direction of the dynamic object.

(Item 4) The information processing apparatus according to Item 2 or 3,
wherein the likelihood function outputs a larger value as an angle (θ_{d}) formed by the movement direction (511) of the dynamic object and a direction (512) from the dynamic object toward each geographic location is smaller.

According to this item, since the intention of the dynamic target can be ascertained based on the movement direction of the dynamic target, it is possible to accurately estimate the destination of the movement of the dynamic object.

(Item 5) The information processing apparatus according to any one of Items 1-4,
wherein the likelihood function is based on whether each geographic location overlaps a static obstacle (502).

According to this item, since the intention of the dynamic target that moves toward the static obstacle can be ascertained, it is possible to accurately estimate the destination of the movement of the dynamic object.

(Item 6) The information processing apparatus according to Item 5,
wherein the likelihood function outputs a larger value in a case where each geographic location overlaps the static obstacle than in a case where each geographic location does not overlap the static obstacle.

According to this item, since the intention of the dynamic target that moves toward the static obstacle can be ascertained, it is possible to accurately estimate the destination of the movement of the dynamic object.

(Item 7) The information processing apparatus according to any one of Items 1-6,
wherein the likelihood function is based on a trajectory (531) along which the dynamic object is predicted to move to reach each geographic location.

According to this item, since the intention of the dynamic target that moves while avoiding the static obstacle can be ascertained, it is possible to accurately estimate the destination of the movement of the dynamic object.

(Item 8) The information processing apparatus according to Item 7,
wherein the likelihood function outputs a larger value as an angle (θ_{d}) formed by the trajectory and the movement direction (511) of the dynamic object is smaller.

According to this item, since the intention of the dynamic target that moves while avoiding the static obstacle can be ascertained, it is possible to accurately estimate the destination of the movement of the dynamic object.

(Item 9) The information processing apparatus according to any one of Items 1-8,
wherein the likelihood function is based on
   a movement direction of the dynamic object,
   whether each geographic location overlaps a static obstacle, and
   a trajectory along which the dynamic object is predicted to move to reach each geographic location.

According to this item, since the likelihood of each geographic location is calculated from various viewpoints, it is possible to accurately estimate the destination of the movement of the dynamic object.

(Item 10) The information processing apparatus according to any one of Items 1-9, further comprising:
a control unit configured to control movement of a mobile object (100) including a sensor (206) configured to observe the dynamic object, based on the estimated geographic location.

According to this item, it is possible to appropriately control the mobile object.

(Item 11) A mobile (100) object comprising:
the information processing apparatus (201) according to any one of Items 1-10; and
a sensor (206) configured to observe a dynamic object.

According to this item, it is possible to provide the mobile object capable of accurately estimating the destination of the movement of the dynamic object.

(Item 12) A non-transitory computer-readable storage medium storing a program for causing a computer (201) to function as the information processing apparatus according to any one of Items 1-11.

According to this item, it is possible to provide the program capable of accurately estimating the destination of the movement of the dynamic object.

(Item 13) An information processing method executed by a computer (201) to estimate a destination of movement of a dynamic object (501), the information processing method comprising:
selecting (S402) a plurality of geographic locations (503) from a vicinity of the dynamic object;
using (S403) a likelihood function (p(i)) to calculate a likelihood that each geographic location is the destination, for each of the plurality of geographic locations using a likelihood function;
reselecting (S404) the plurality of geographic locations based on the likelihood of each geographic location; and
estimating (S406) the destination based on the plurality of reselected geographic locations,
wherein the likelihood function is based on at least one of a state of the dynamic object and a position of an obstacle (502) around the dynamic object.

According to this item, it is possible to accurately estimate the destination of the movement of the dynamic object.

(Item 14) A system configured to estimate a destination of movement of a dynamic object (501), the system comprising:
a selection unit configured to select a plurality of geographic locations (503) from a vicinity of the dynamic object;
a calculation unit configured to use a likelihood function (p(i)) to calculate a likelihood that each geographic location is the destination, for each of the plurality of geographic locations;
a reselection unit configured to reselect the plurality of geographic locations based on the likelihood of each geographic location; and
an estimation unit configured to estimate the destination based on the plurality of reselected geographic locations,
wherein the likelihood function is based on at least one of a state of the dynamic object and a position of an obstacle (502) around the dynamic object.

According to this item, it is possible to accurately estimate the destination of the movement of the dynamic object.

The invention is not limited to the foregoing embodiments, and various variations/changes are possible within the spirit of the invention.

What is claimed is:

1. An information processing apparatus configured to estimate a destination of movement of a dynamic object, the information processing apparatus comprising:
a selection unit configured to select a plurality of geographic locations from a vicinity of the dynamic object;
a calculation unit configured to use a likelihood function to calculate a likelihood that each geographic location is the destination, for each of the plurality of geographic locations;
a reselection unit configured to reselect the plurality of geographic locations based on the likelihood of each geographic location; and
an estimation unit configured to estimate the destination based on the plurality of reselected geographic locations,
wherein the likelihood function is based on at least one of a state of the dynamic object and a position of an obstacle around the dynamic object.

2. The information processing apparatus according to claim 1,
wherein the likelihood function is based on a movement direction of the dynamic object.

3. The information processing apparatus according to claim 2,
wherein the movement direction of the dynamic object is decided based on an orientation of a body of the dynamic object.

4. The information processing apparatus according to claim 2,
wherein the likelihood function outputs a larger value as an angle formed by the movement direction of the dynamic object and a direction from the dynamic object toward each geographic location is smaller.

5. The information processing apparatus according to claim 1,
wherein the likelihood function is based on whether each geographic location overlaps a static obstacle.

6. The information processing apparatus according to claim 5,
wherein the likelihood function outputs a larger value in a case where each geographic location overlaps the static obstacle than in a case where each geographic location does not overlap the static obstacle.

7. The information processing apparatus according to claim 1,
wherein the likelihood function is based on a trajectory along which the dynamic object is predicted to move to reach each geographic location.

8. The information processing apparatus according to claim 7,
wherein the likelihood function outputs a larger value as an angle formed by the trajectory and the movement direction of the dynamic object is smaller.

9. The information processing apparatus according to claim 1,
wherein the likelihood function is based on
a movement direction of the dynamic object,
whether each geographic location overlaps a static obstacle, and
a trajectory along which the dynamic object is predicted to move to reach each geographic location.

10. The information processing apparatus according to claim 1, further comprising:
a control unit configured to control movement of a mobile object including a sensor configured to observe the dynamic object, based on the estimated geographic location.

11. A mobile object comprising:
the information processing apparatus according to claim 1; and
a sensor configured to observe a dynamic object.

12. A non-transitory computer-readable storage medium storing a program for causing a computer to function as the information processing apparatus according to claim 1.

13. An information processing method executed by a computer to estimate a destination of movement of a dynamic object, the information processing method comprising:
selecting a plurality of geographic locations from a vicinity of the dynamic object;
using a likelihood function to calculate a likelihood that each geographic location is the destination, for each of the plurality of geographic locations using a likelihood function;
reselecting the plurality of geographic locations based on the likelihood of each geographic location; and
estimating the destination based on the plurality of reselected geographic locations,
wherein the likelihood function is based on at least one of a state of the dynamic object and a position of an obstacle around the dynamic object.

14. A system configured to estimate a destination of movement of a dynamic object, the system comprising:
a selection unit configured to select a plurality of geographic locations from a vicinity of the dynamic object;
a calculation unit configured to use a likelihood function to calculate a likelihood that each geographic location is the destination, for each of the plurality of geographic locations;
a reselection unit configured to reselect the plurality of geographic locations based on the likelihood of each geographic location; and
an estimation unit configured to estimate the destination based on the plurality of reselected geographic locations,
wherein the likelihood function is based on at least one of a state of the dynamic object and a position of an obstacle around the dynamic object.
